(19) United States
(12) Patent Application Publication
(10) Pub. No.: US 2025/0299868 A1
(43) Pub. Date: Sep. 25, 2025

(54) MULTILAYER COIL COMPONENT

(71) Applicant: TDK CORPORATION, Tokyo (JP)

(72) Inventors: Yuto Shiga, Tokyo (JP); So Kobayashi, Tokyo (JP); Teru Ishimori, Tokyo (JP); Youichi Kazuta, Tokyo (JP); Xuran Guo, Tokyo (JP)

(73) Assignee: TDK CORPORATION, Tokyo (JP)

(21) Appl. No.: 19/079,574

(22) Filed: Mar. 14, 2025

(30) Foreign Application Priority Data
Mar. 22, 2024 (JP) 2024-046969

(51) Int. Cl. H01F 27/28; H01F 27/29; H01F 27/32

(52) U.S. Cl. CPC H01F 27/2804; H01F 27/292; H01F 27/323; H01F 2027/2809

(57) ABSTRACT

A multilayer coil component includes an element body, a coil disposed in the element body, an external electrode disposed on a surface of the element body, and a connection conductor disposed in the element body. The coil includes a plurality of coil conductors arranged along a direction. The external electrode is adjacent to the coil 3 in a direction orthogonal to the direction D1. The connection conductor electrically connects the coil and the external electrode. The plurality of coil conductors includes an endmost coil conductor including an end of the coil and physically connected to the connection conductor. The connection conductor has a thickness larger than a thickness of a portion having the thickness smallest in the coil.

### CROSS-REFERENCE TO RELATED APPLICATIONS

This application is based upon and claims the benefit of priority from Japanese Patent Application No. 2024-046969, filed On Mar. 22, 2024, the entire contents of which are incorporated herein by reference.

### BACKGROUND

### Field

The present disclosure relates to a multilayer coil component.

### Description of the Related Art

There is known a multilayer coil component including an element body, a coil in the element body, an external electrode on a surface of the element body, and a connection conductor electrically connecting the coil and the external electrode (for example, Japanese Unexamined Patent Publication No. 2018-113309).

### SUMMARY

An object of one aspect of the present disclosure is to provide a multilayer coil component capable of improving a quality factor (hereinafter, referred to as Q Factor).

The multilayer coil component according to one aspect of the present disclosure includes an element body, a coil in the element body, an external electrode on a surface of the element body, and a connection conductor in the element body. The coil includes a plurality of coil conductors arranged along a first direction. The external electrode is adjacent to the coil in a second direction orthogonal to the first direction. The connection conductor electrically connects the coil and the external electrode. The plurality of coil conductors includes an endmost coil conductor including an end of the coil and physically connected to the connection conductor. The connection conductor has a thickness larger than a thickness of a portion having the thickness smallest in the coil.

The Q factor of the multilayer coil component is inversely proportional to an electric resistance. The electric resistance of the multilayer coil component in which the connection conductor electrically connects the coil and the external electrode depends on the combined resistance of the coil and the connection conductor. Since the electric resistance of the conductor is inversely proportional to the cross-sectional area of the conductor, the electric resistance of the connection conductor changes based on the thickness of the connection conductor. Therefore, the Q factor of the multilayer coil component changes based on the thickness of the connection conductor.

In a multilayer coil component, a plurality of inductance values are required for a predetermined outer shape size. The inductance value is inversely proportional to the magnetic path length. Since the magnetic path length depends on the thickness of each of the plurality of coil conductors included in the coil, the thickness of the coil tends not to be a constant value.

In order to obtain a multilayer coil component having a high inductance value, the magnetic path length may be reduced by reducing the thickness of the coil conductor. When the thickness of the coil conductor is reduced, the cross-sectional area of the coil conductor is reduced, so that the electric resistance of the multilayer coil component is increased. Therefore, in the multilayer coil component having the high inductance value, the Q factor of the multilayer coil component tends to decrease.

In a multilayer coil component, since the influence on the magnetic path length of the connection conductor is small, the thickness of the connection conductor tends not to significantly affects the inductance value. When the thickness of the connection conductor is increased, the cross-sectional area of the connection conductor is increased, so that the electric resistance of the multilayer coil component is reduced. Therefore, by increasing comparatively the thickness of the connection conductor, it is possible to provide a multilayer coil component in which a decrease in the Q factor is suppressed while having a high inductance value.

In the one aspect described above, the connection conductor has the thickness larger than the thickness of a portion having the thickness smallest in the coil. The electric resistance of the connection conductor in the one aspect is smaller than the electric resistance of the connection conductor in a configuration in which the connection conductor has a thickness equal to or less than the thickness of the portion having the thickness smallest in the coil. Therefore, the one aspect suppresses a decrease in the Q factor of the multilayer coil component.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view of a multilayer coil component according to an embodiment;

FIG. 2 is a perspective view of a coil according to the present embodiment;

FIG. 3 is a plan view of the coil according to the present embodiment as viewed from a side surface;

FIG. 4 is a plan view of the coil according to the present embodiment as viewed from a main surface; and

FIG. 5 is an exploded view illustrating a configuration of the multilayer coil component according to the present embodiment.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

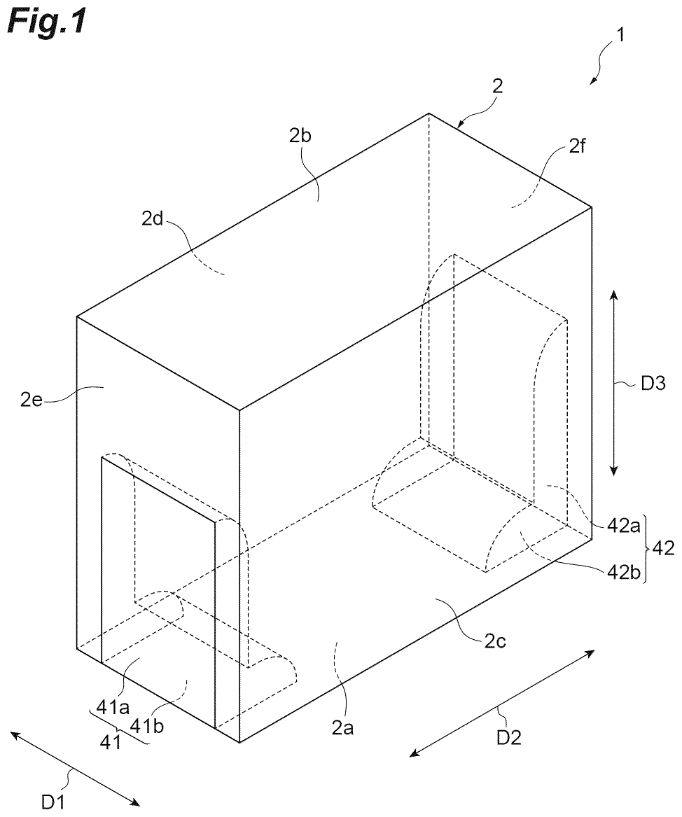

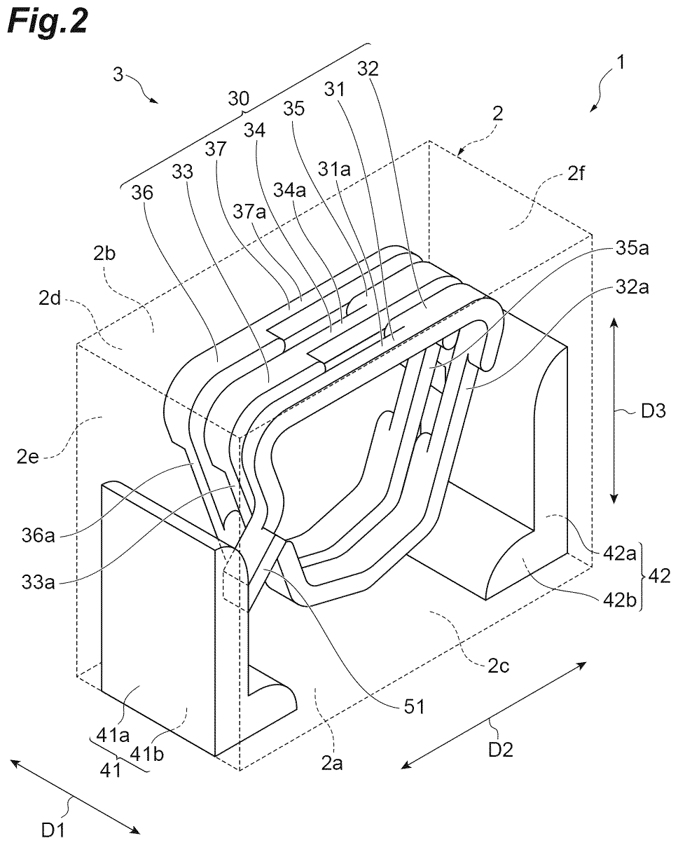

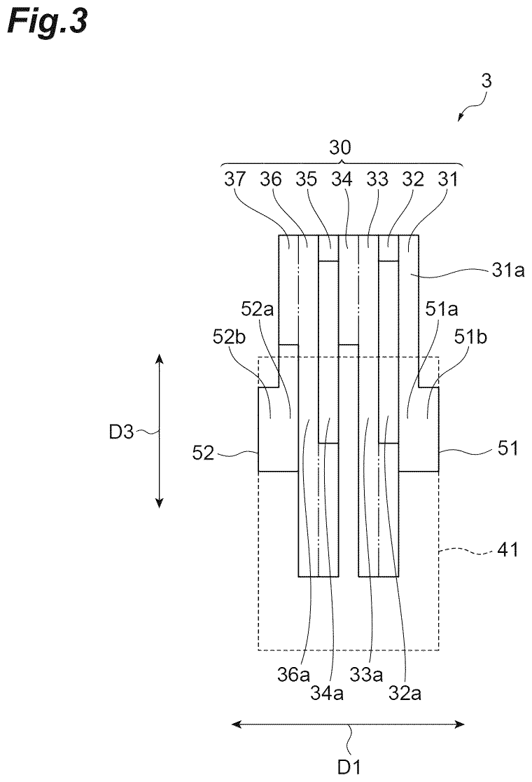

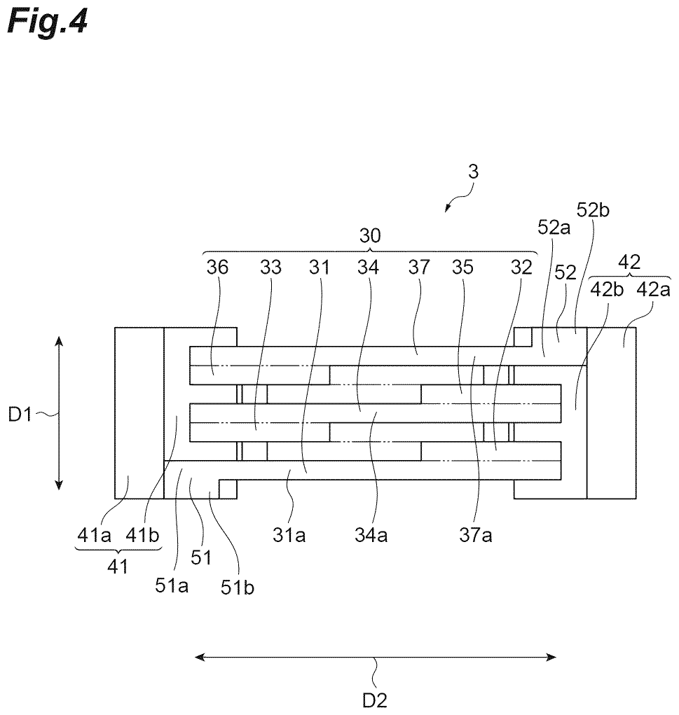

With reference to FIGS. 1 to 4, the configuration of the multilayer coil component 1 according to the present embodiment will be described. FIG. 1 is the perspective view of the multilayer coil component according to the present embodiment. FIG. 2 is the perspective view of the coil according to the present embodiment. FIG. 3 is the plan view of the coil according to the present embodiment as viewed from a side surface 2e illustrated in FIG. 1. FIG. 4 is the plan view of the coil according to the present embodiment as viewed from a main surface 2b illustrated in FIG. 1. The multilayer coil component 1 according to the present embodiment is solder-mounted to an electronic device. The electronic device includes, for example, a circuit board or an electronic component.

As illustrated in FIGS. 1 and 2, the multilayer coil component 1 includes an element body 2, the coil 3 in the element body 2, a pair of external electrodes 41 and 42 on surfaces of the element body 2, and a pair of connection conductors 51 and 52 in the element body 2. The external electrodes 41 and 42 are electrically connected to the coil 3. The element body 2 has a rectangular parallelepiped shape. The rectangular parallelepiped shape includes a rectangular parallelepiped shape in which corner and ridge are chamfered, or a rectangular parallelepiped shape in which corner and ridge are rounded.

The element body 2 includes a pair of main surfaces 2a and 2b, a pair of side surfaces 2c and 2d, and a pair of side surfaces 2e and 2f. The pair of main surfaces 2a and 2b oppose each other. The pair of side surfaces 2c and 2d oppose each other. The pair of side surfaces 2e and 2f oppose each other. The main surfaces 2a and 2b, the side surfaces 2c and 2d, and the side surfaces 2e and 2f have rectangular shapes. The main surfaces 2a and 2b are adjacent to the side surfaces 2c and 2d and the side surfaces 2e and 2f. The side surfaces 2c and 2d are each adjacent to the side surfaces 2e and 2f. When the multilayer coil component 1 is solder-mounted on the electronic device, the main surface 2a faces the electronic device to be solder-mounted. The main surfaces 2a and 2b, the side surfaces 2c and 2d, and the side surfaces 2e and 2f are flat surfaces. The flat surface means a surface formed so as to be a flat surface and is not limited to a geometrically complete flat surface. The flat surface may include curvature and unevenness that occur in a manufacturing process.

A direction D3 in which the pair of main surfaces 2a and 2b oppose each other is orthogonal to each of the main surfaces 2a and 2b. A direction D1 in which the pair of side surfaces 2c and 2d oppose each other is orthogonal to each of the side surfaces 2c and 2d. A direction D2 in which the pair of side surfaces 2e and 2f oppose each other is orthogonal to each of the side surfaces 2e and 2f. The direction D3 is orthogonal to the direction D1 and the direction D2. The direction D1 and the direction D2 are orthogonal to each other. A pair of recesses corresponding to the pair of external electrodes 41 and 42 is formed in the element body 2. For example, the direction D1 includes a first direction, the direction D2 may include a second direction, and the direction D3 may include the second direction.

The external electrodes 41 and 42 have L-shaped cross sections when viewed from the direction D1. The recesses corresponding to the external electrodes 41 and 42 formed in the element body 2 have L shapes when viewed from the direction D1. The external electrode 41 includes a portion 41a and a portion 41b. A surface of the portion 41a is oriented in the same orientation as the side surface 2e, and a surface of the portion 41b is oriented in the same orientation as the main surface 2a. The portion 41a and the portion 41b are continuous along a ridge portion between the side surface 2e and the main surface 2a. The external electrode 42 includes a portion 42a and a portion 42b. A surface of the portion 42a is oriented in the same orientation as the side surface 2f, and a surface of the portion 42b is oriented in the same orientation as the main surface 2a. The portion 42a and the portion 42b are continuous along a ridge portion between the side surface 2f and the main surface 2a. The external electrodes 41 and 42 are adjacent to the coil 3 in a direction orthogonal to the direction D1.

In the present embodiment, lengths of the external electrodes 41 and 42 in the direction D3 are longer than lengths of the external electrodes 41 and 42 in the direction D2. The portions 41b and 42b are disposed to be exposed in the same orientation as the main surface 2a. Surfaces of the portions 41b and 42b and the main surface 2a may be located on the same flat surface. The surfaces of the portions 41b and 42b may protrude from the main surface 2a. The portion 41a is disposed to be exposed in the same orientation as the side surface 2e. The surface of the portion 41a and the side surface 2e may be located on the same flat surface. The surface of the portion 41a may protrude from the side surface 2e. The portion 42a is disposed on the side surface 2f to be exposed in the same orientation as the side surface 2f. The surface of the portion 42a and the side surface 2f may be located on the same surface. The surface of the portion 42a may protrude from the side surface 2f. In the present embodiment, lengths of the portions 41a and 42a in the direction D3 are longer than lengths of the portions 41b and 42b in the direction D2.

As illustrated in FIGS. 2 to 4, the coil 3 includes a plurality of coil conductors 30. The plurality of coil conductors 30 are electrically connected to each other. The plurality of coil conductors 30 includes coil conductors 31, 32,33,34,35, 36 and 37. The coil conductors 31 to 37 are arranged in this order (the coil conductor 31, the coil conductor 32, the coil conductor 33, the coil conductor 34, the coil conductor 35, the coil conductor 36, the coil conductor 37) along the direction D1 and are adjacent to each other. The coil conductor 31 is an endmost coil conductor including one end of the coil 3 in the direction D1. The coil conductor 37 is an endmost coil conductor including the other end of the coil 3 in the direction D1. The coil 3 includes seven coil conductors 31 to 37 coupled in the direction D1. The number of turns of the coil 3 is 2.5. Each of the coil conductors 31 to 37 constitutes a part of an annular track in the coil 3. Each of the coil conductors 31 to 37 has, for example, a shape in which a part of a loop is interrupted. The plurality of coil conductors 30 each has a path length and a thickness. The axial direction of the coil 3 is along the main surface 2a.

The respective coil conductors 31 to 37 includes a first end and a second end. The first end corresponds to one end in the shape in which the part of the loop is interrupted. The second end corresponds to the other end in the shape in which the part of the loop is interrupted. The respective coil conductors 31 to 37 extends along paths from the first ends to the second ends in respective layers of the coil conductors 31 to 37. Lengths of the paths from the first ends to the second ends of the respective coil conductors 31 to 37 are referred to as path lengths of the respective coil conductors 31 to 37, respectively. The path length may be the minimum length from an end surface of a first end to an end surface of a second end of the respective coil conductors 31 to 37. For example, the path length may be an inner circumference from the first end surface to the second end surface of the respective coil conductor 31 to 37. Each layer of the coil conductors 31 to 37 corresponds to each layer constituting the multilayer coil component 1. Each layer of the coil conductors 31 to 37 extends along a flat surface intersecting the direction D1 in which the coil conductors 31 to 37 are arranged. In the present embodiment, each layer of the coil conductors 31 to 37 extends along the direction D2 and the direction D3.

Widths of the respective coil conductors 31 to 37 in a direction orthogonal to paths of the respective coil conductors 31 to 37 are equal to each other. In the present specification, the term “equal” does not necessarily mean that values coincide with each other. Even in a case where values include slight differences, manufacturing errors, or measurement errors within a preset range, the values may be regarded as being equal to each other.

The thicknesses of the coil conductors 31 to 37 are equal to each other. In the present specification, the “thickness” of the coil conductor is a distance along the direction D1 between one surface of the coil conductor in the direction D1 and the other surface located opposite to the one surface. The average distance between one surface and the other surface of the coil conductor in the direction D1 may be set as the thickness of the coil conductor.

Ends of a pair of coil conductors adjacent to each other among the plurality of coil conductors 30 overlap each other and are coupled to each other. In the present embodiment, the ends of a pair of coil conductors adjacent to each other among the plurality of coil conductors 30 completely overlap each other. However, the ends may at least partially overlap each other. The coil conductors 31 and 32, the coil conductors 32 and 33, the coil conductors 33 and 34, the coil conductors 34 and 35, the coil conductors 35 and 36, and the coil conductors 36 and 37 are a pair of coil conductors adjacent to each other in the direction D1. For example, the second end of the coil conductor 31 and the first end of the coil conductor 32 overlap each other in the direction D1 and are coupled to each other. A pair of coil conductors adjacent to each other among the plurality of coil conductors 30 is directly and physically connected to each other at each end.

The portion 31a is a portion of the coil conductor 31 that does not overlap the coil conductor 32. The portion 32a is a portion of the coil conductor 32 that does not overlap the coil conductor 31 or the coil conductor 33. The portion 33a is a portion of the coil conductor 33 that does not overlap the coil conductor 32 or the coil conductor 34. The portion 34a is a portion of the coil conductor 34 that does not overlap the coil conductor 33 or the coil conductor 35. The portion 35a is a portion of the coil conductor 35 that does not overlap the coil conductor 34 or the coil conductor 36. The portion 36a is a portion of the coil conductor 36 that does not overlap the coil conductor 35 or the coil conductor 37. The portion 37a is a portion of the coil conductor 37 that does not overlap the coil conductor 36. In the present embodiment, the thicknesses of the portions 31a to 37a are equal to each other. The portions 31a to 37a are portions other than the end portion of each coil conductors 31 to 37, and are portions that do not overlap and are not coupled to the end of the adjacent coil conductor. In the present embodiment, the portions 31a to 37a are portions of the coil 3 having the smallest thickness.

The connection conductor 51 electrically connects the coil 3 and the external electrode 41 to each other. The coil conductor 31 is physically connected to the connection conductor 51. The connection conductor 51 extends so as to connect the first end of the coil conductor 31 and the portion 41a of the external electrode 41. The connection conductor 51 has a thickness larger than a thickness of a portion having the thickness smallest in the coil 3. For example, the thickness of the connection conductor 51 includes a first thickness, and the thickness of the potion having the thickness smallest in the coil 3 includes a second thickness. In the present embodiment, the connection conductor 51 has a thickness larger than that of any of the portions 31a to 37a. The connection conductor 51 has a thickness larger than a thickness of the portion 31a having the smallest thickness of the coil conductor 31. For example, the thickness of the portion 31a having the smallest thickness of the coil conductor 31 includes a third thickness. The second thickness may be equal to the third thickness. The connection conductor 51 includes a portion 51a continuous with the coil conductor 31 in the same layer as the coil conductor 31, and a portion 51b disposed in a layer outside the coil conductor 31 in the direction D1. The outside of the coil conductor 31 in the direction D1 means to be closer to the side surface 2c than the coil conductor 31. In the present embodiment, the portion 51a and the portion 51b completely overlap each other, however, the portion 51a and the portion 51b may at least partially overlap each other.

In the direction D1, the connection conductor 51 protrudes further outward from the coil conductor 31 than the connection conductor 51 protrudes inward. A portion of the connection conductor 51 protruding outward of the coil conductor 31 is larger than a portion of the connection conductor 51 protruding inward of the coil conductor 31 in the direction D1. The center of the thickness of the connection conductor 51 is located outside the center of the thickness of the coil conductor 31 in the direction D1. The connection conductor 51 does not include a portion protruding inward of the coil conductor 31 in the direction D1. The inside of the coil conductor 31 in the direction D1 means to be closer to the center of the element body 2 than the coil conductor 31 in the direction D1. The portion 51b protrudes outward from the coil conductor 31 and the portion 51a in the direction D1. The connection conductor 52 electrically connects the coil 3 and

the external electrode 42 to each other. The coil conductor 31 is physically connected to the connection conductor 52. The connection conductor 52 extends so as to connect the second end of the coil conductor 37 and the portion 42a of the external electrode 42. The connection conductor 52 has a thickness larger than a thickness of a portion having the thickness smallest in the coil 3. For example, the thickness of the connection conductor 52 includes the first thickness, and the thickness of the potion having the thickness smallest in the coil 3 includes the second thickness. In the present embodiment, the connection conductor 52 has a thickness larger than that of any of the portions 31a to 37a. The connection conductor 52 has a thickness larger than a thickness of the portion 37a having the smallest thickness of the coil conductor 37. For example, the thickness of the portion 37a having the smallest thickness of the coil conductor 31 includes a third thickness. The second thickness may be equal to the third thickness. The connection conductor 52 includes a portion 52a continuous with the coil conductor 37 in the same layer as the coil conductor 37, and a portion 52b disposed in a layer outside the coil conductor 37 in the direction D1. The outside of the coil conductor 37 in the direction D1 means to be closer to the side surface 2d than the coil conductor 37. In the present embodiment, the portion 52a and the portion 52b completely overlap each other, however, the portion 52a and the portion 52b may at least partially overlap each other.

In the direction D1, the connection conductor 52 protrudes further outward from the coil conductor 37 than the connection conductor 52 protrudes inward. A portion of the connection conductor 52 protruding outward of the coil conductor 37 is larger than a portion of the connection conductor 52 protruding inward of the coil conductor 37 in the direction D1. The center of the thickness of the connection conductor 52 is located outside the center of the thickness of the coil conductor 37 in the direction D1. The connection conductor 52 does not include a portion protruding inward of the coil conductor 37 in the direction D1. The inside of the coil conductor 37 in the direction D1 means to be closer to the center of the element body 2 than the coil conductor 37 in the direction D1. The portion 52b protrudes outward from the coil conductor 37 and the portion 52a in the direction D1.

Respective thicknesses of the connection conductor 51 and the connection conductor 52 are equal to each other. Respective widths of the connection conductor 51 and the connection conductor 52 are equal to each other. The widths of the connection conductor 51 and the connection conductor 52 may be equal to the widths of the plurality of coil conductors 30. The connection conductors 51 and 52 have a thickness larger than the thickness of at least one of the coil conductors 31 to 37. The connection conductors 51 and 52 have a thickness that is 1.25 times or more the thickness of at least one of the portions 31a to 37a. The connection conductors 51 and 52 may have a thickness equal to twice the thickness of at least one of the portions 31a to 37a. When viewed from the direction D1, the connection conductors 51 and 52 does not overlap the coil 3. The connection conductors 51 and 52 do not overlap the coil 3.

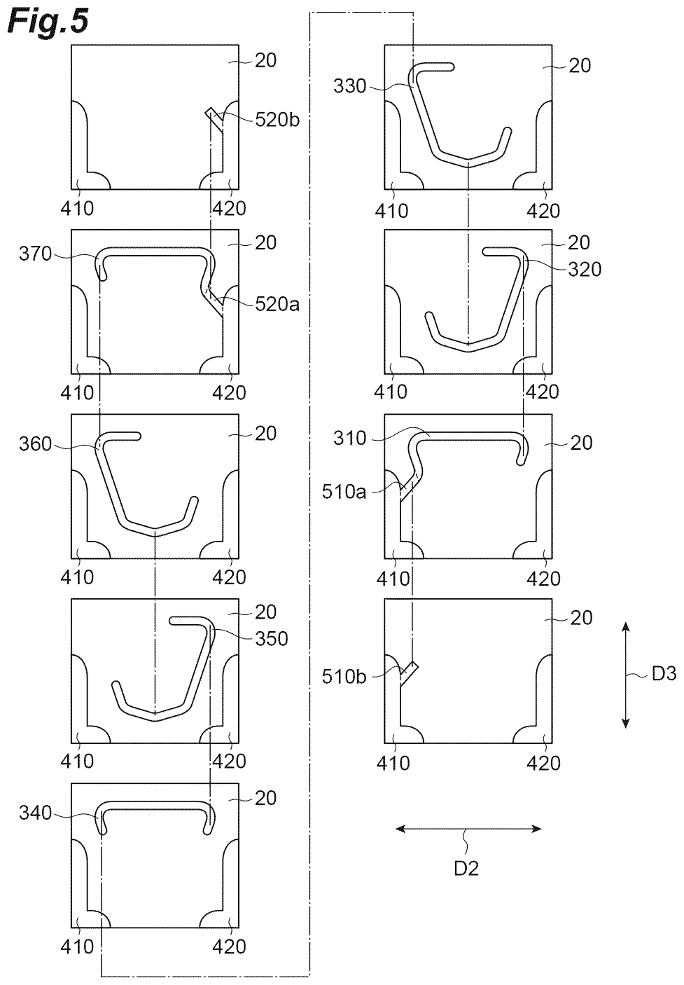

FIG. 5 is an exploded view illustrating a configuration of the multilayer coil component 1 according to the present embodiment. In the present embodiment, a lamination direction of the multilayer coil component 1 is along the direction D1. FIG. 5 illustrates a plurality of layers constituting the multilayer coil component 1 as viewed from the direction D1. The plurality of layers constituting the multilayer coil component 1 includes a layer constituting the element body 2, a layer constituting the coil 3, layers constituting the external electrodes 41 and 42, and layers constituting the connection conductors 51 and 52. Thicknesses of the plurality of layers are equal to each other. Hereinafter, with reference to FIG. 5, the element body 2, the plurality of coil conductors 30 of the coil 3, the external electrodes 41 and 42, and the connection conductors 51 and 52 will be described.

The element body 2 includes a plurality of laminated insulator layers 20. In the present embodiment, the number of the plurality of insulator layers 20 is “13”. FIG. 5 illustrates nine insulator layers 20 while two insulator layers 20 located at each end in the direction D1 are omitted. In the actual element body 2, the respective insulator layers 20 are integrated to such an extent that boundaries between the insulator layers 20 cannot be visually recognized. Each of the insulator layers 20 includes, for example, a nonmagnetic material. The nonmagnetic material includes, for example, a glass ceramic material or a dielectric material. In the present embodiment, each insulator layer 20 includes a sintered body of a green sheet including a nonmagnetic material. Each of the insulator layers 20 may include, for example, a magnetic material.

The external electrode 41 and the external electrode 42 include a plurality of laminated electrode layers 410 and a plurality of laminated electrode layers 420, respectively. In the present embodiment, the number of the plurality of electrode layers 410 and the number of the plurality of electrode layers 420 are each “9”. In the actual external electrode 41, the respective electrode layers 410 are integrated to such an extent that boundaries between the electrode layers 410 cannot be visually recognized. In the actual external electrode 42, the respective electrode layers 420 are integrated to such an extent that boundaries between the electrode layers 420 cannot be visually recognized. Each of the electrode layers 410 and 420 is provided in a defective portion formed in the corresponding insulator layers 20. A pair of recesses corresponding to the external electrodes 41 and 42 is obtained by the defective portions formed in the respective insulator layers 20. Each of the electrode layers 410 and 420 includes, for example, a conductive material. The conductive material includes, for example, Ag or Pd. In the present embodiment, each of the electrode layers 410 and 420 includes a sintered body of a conductive paste including powder of the conductive material.

The connection conductor 51 includes two electrode layers corresponding to each of the portion 51a and the portion 51b. The portion 51a includes an electrode layer 510a. The electrode layer 510a is continuous with the coil conductor layer 310. The portion 51b includes an electrode layer 510b. The electrode layer 510a and the electrode layer 510b entirely overlap each other. In the actual connection conductor 51, the electrode layer 510a and the electrode layer 510b are integrated to such an extent that boundaries between the electrode layer 510a and the electrode layer 510b cannot be visually recognized. Each of the electrode layers 510a and 510b is provided in a defective portion formed in the corresponding insulator layers 20. Each of the electrode layer 510a and 510b includes, for example, the same material as that of each of the electrode layers 410 and 420. Each of the electrode layers 510a and 510b includes, for example, a sintered body of a conductive paste.

The connection conductor 52 includes two electrode layers corresponding to each of the portion 52a and the portion 52b. The portion 52a includes an electrode layer 520a. The electrode layer 520a is continuous with the coil conductor layer 370. The portion 52b includes an electrode layer 520b. The electrode layer 520a and the electrode layer 520b entirely overlap each other. In the actual connection conductor 52, the electrode layer 520a and the electrode layer 520b are integrated to such an extent that boundaries between the electrode layer 520a and the electrode layer 520b cannot be visually recognized. Each of the electrode layers 520a and 520b is provided in a defective portion formed in the corresponding insulator layers 20. Each of the electrode layer 520a and 520b includes, for example, the same material as that of each of the electrode layers 410 and 420. Each of the electrode layers 520a and 520b includes, for example, a sintered body of a conductive paste.

The plurality of coil conductors 30 includes a plurality of coil conductor layers corresponding to each of the plurality of coil conductors 30. The coil conductors 31 to 37 include the coil conductor layers 310 to 370, respectively. Each of the coil conductor layers 310 to 370 is provided in a defective portion formed in the corresponding insulator layer 20. Each of the coil conductor layers 310 to 370 includes, for example, the same material as that of each of the electrode layers 410 and 420. Each of the coil conductor layers 310 to 370 includes, for example, a sintered body of a conductive paste.

Hereinafter, with reference to FIGS. 2 and 5, the coil 3 and the plurality of coil conductors 30 will be described. The coil conductor layers 310 to 370 illustrated in FIG. 5 correspond to the coil conductors 31 to 37 viewed from the direction D1.

When viewed from the direction D1, the coil 3 has a pentagonal shape. The pentagon is line-symmetric in the direction D2 relative to a center line along the direction D3. The pentagon includes a first side located closest to the main surface 2b, a second side located closest to the side surface 2f, a third side and a fourth side located closest to the main surface 2a, and a fifth side located closest to the side surface 2e. The first side and the second side are connected at a first vertex, the second side and the third side are connected at a second vertex, the third side and the fourth side are connected at a third vertex, the fourth side and the fifth side are connected at a fourth vertex, and the fifth side and the first side are connected at a fifth vertex. With respect to a center line passing through the third vertex between the third side and the fourth side, the second side and the fifth side are line-symmetric with each other, and the third side and the fourth side are line-symmetric with each other. The first side is longer than each of the second side and the fifth side. Each of the second side and the fifth side is longer than each of the third side and the fourth side. When viewed from the direction D1, each path of the plurality of coil conductors 30 includes at least one of the first side to the fifth side.

The paths of the coil conductors 31, 34, and 37 include the first side. Path lengths of the coil conductors 31, 34, and 37 are each a ½ turn or less. The paths of the coil conductors 32 and 35 include the second side, the third side, and the fourth side. The paths of the coil conductors 33 and 36 include the third side, the fourth side, and the fifth side. Path lengths of the coil conductors 32, 33, 35 and 36 are each a ½ turn or more. Each of the coil conductors 33 and 35 have path lengths longer than the path lengths of the respective coil conductors 31, 34, and 37. The coil conductors 33 and 35 may have the longest path length among the plurality of coil conductors 30. The coil conductors 31, 34, and 37 may have the shortest path length among the plurality of coil conductors 30.

As described above, in the multilayer coil component 1, the connection conductors 51 and 52 have a thickness larger than a thickness of a portion having the thickness smallest in the coil 3. The electric resistance of the connection conductors 51 and 52 in the multilayer coil component 1 is smaller than the electric resistance of the connection conductors 51 and 52 in a configuration in which the connection conductors 51 and 52 have a thickness equal to or less than the thickness of the portion having the thickness smallest in the coil 3. Therefore, the multilayer coil component 1 suppresses a decrease in the Q factor of the multilayer coil component.

The connection conductor 51 includes a portion continuous with the coil conductor 31 in the same layer as the coil conductor 31, and the connection conductor 52 includes a portion continuous with the coil conductor 37 in the same layer as the coil conductor 37.

A connection conductor that does not include a portion continuous with the coil conductors 31 and 37 in the same layer as the coil conductors 31 and 37 is coupled to the coil conductors 31 and 37 in the direction D1 in a layer different from the coil conductors 31 and 37. Since the portion coupled to the coil conductors 31 and 37 in the direction D1 is included in the layer different from the coil conductors 31 and 37, the path through which the current of the connection conductor that does not include the portion continuous with the coil conductors 31 and 37 in the same layer as the coil conductors 31 and 37 flows is longer than the path through which the current of the connection conductors 51 and 52 flows. Therefore, the electric resistance of the connection conductor that does not include the portion continuous with the coil conductors 31 and 37 in the same layer as the coil conductors 31 and 37 is larger than the electric resistance of the connection conductors 51 and 52. Since the electric resistance of the connection conductors 51 and 52 is smaller than that of a connection conductor that does not include a portion continuous with the coil conductors 31 and 37 in the same layer as the coil conductors 31 and 37, the multilayer coil component 1 suppresses a decrease in the Q factor of the multilayer coil component.

When viewed from the direction D1, the connection conductors 51 and 52 does not overlap the coil 3.

Since the connection conductors 51 and 52 and the coil 3 do not overlap each other when viewed from the direction D1, a change in the magnetic path length is small as compared with a case where the connection conductors 51 and 52 and the coil 3 overlap each other. Therefore, the multilayer coil component 1 suppresses a decrease in the inductance value.

The connection conductor 51 has a thickness larger than a thickness of the portion 31a having the smallest thickness of the coil conductor 31. The connection conductor 52 has a thickness larger than a thickness of the portion 37a having the smallest thickness of the coil conductor 37.

The electric resistance of the connection conductor 51 is smaller than the electric resistance of the connection conductor 51 in a configuration in which the connection conductor 51 has a thickness equal to or less than the thickness of the portion 31a. The electric resistance of the connection conductor 52 is smaller than the electric resistance of the connection conductor 52 in a configuration in which the connection conductor 52 has a thickness equal to or less than the thickness of the portion 37a. Therefore, the multilayer coil component 1 suppresses a decrease in the Q factor of the multilayer coil component.

A portion of the connection conductor 51 protruding outward of the coil conductor 31 is larger than a portion of the connection conductor 51 protruding inward of the coil conductor 31 in the direction D1. A portion of the connection conductor 52 protruding outward of the coil conductor 37 is larger than a portion of the connection conductor 52 protruding inward of the coil conductor 37 in the direction D1.

The portion of the connection conductor 51 protruding inward of the coil conductor 31 is smaller than a portion of a connection conductor that protrudes inward of the coil conductor 31 and is larger than a portion of the connection conductor protruding outward of the coil conductor 31, so that the area where the connection conductor 51 and the coil 3 face each other in the direction orthogonal to the direction D1 is small. As a result, since the stray capacitance generated between the connection conductor 51 and the coil 3 is small, the multilayer coil component 1 suppresses a decrease in the self-resonant frequency.

The portion of the connection conductor 52 protruding inward of the coil conductor 37 is smaller than a portion of a connection conductor that protrudes inward of the coil conductor 37 and is larger than a portion of the connection conductor protruding outward of the coil conductor 37, so that the area where the connection conductor 52 and the coil 3 face each other in the direction orthogonal to the direction D1 is small. As a result, since the stray capacitance generated between the connection conductor 52 and the coil 3 is small, the multilayer coil component 1 suppresses a decrease in the self-resonant frequency.

Since the connection conductor 51 does not include a portion protruding inward of the coil conductor 31, the connection conductor 51 and the coil 3 do not face each other in the direction orthogonal to the direction D1. Since the connection conductor 52 does not include a portion protruding inward of the coil conductor 37, the connection conductor 52 and the coil 3 do not face each other in the direction orthogonal to the direction D1. Therefore, the multilayer coil component 1 suppresses a decrease in the self-resonant frequency.

The present disclosure has been described in detail based on the embodiments. However, the present disclosure is not limited to the above embodiments. The present disclosure can be variously modified without departing from the scope of the present disclosure.

At least one of the connection conductors 51 and 52 may have a thickness larger than a thickness of a portion having the thickness smallest in the coil 3. At least one of the connection conductors 51 and 52 may have a thickness larger than a thickness of at least one of the portions 31a to 37a. In the multilayer coil component 1, since both of the connection conductors 51 and 52 have a thickness larger than the thickness of any of the portions 31a to 37a, the multilayer coil component 1 further suppresses the decrease in the Q factor of the multilayer coil component.

The connection conductors 51 and 52 do not necessarily include a portion continuous with the endmost coil conductors 31 and 37 in the same layer as the endmost coil conductors 31 and 37.

The connection conductors 51 and 52 may be continuous with the endmost coil conductors 31 and 37 in the same layer as the endmost coil conductors 31 and 37.

The connection conductors 51 and 52 may have a thickness equal to the thickness of the endmost coil conductors 31 and 37.

The coil 3 is not limited to a pentagonal shape. The coil 3 may have a quadrangular shape or may have a circular shape.

What is claimed is:

1. A multilayer coil component comprising:
an element body;
a coil in the element body including a plurality of coil conductors arranged along a first direction;
an external electrode on a surface of the element body adjacent to the coil in a second direction orthogonal to the first direction; and
a connection conductor in the element body electrically connecting the coil and the external electrode to each other, wherein
the plurality of coil conductors includes an endmost coil conductor that includes an end of the coil and is physically connected to the connection conductor, and
the connection conductor has a first thickness that is larger than a second thickness of a smallest thickness portion in the coil.

2. The multilayer coil component according to claim 1, wherein the connection conductor does not overlap the coil when viewed from the first direction.

3. The multilayer coil component according to claim 1, wherein the connection conductor has the first thickness that is larger than a third thickness of a smallest thickness in the endmost coil conductor.

4. The multilayer coil component according to claim 1, wherein, in the first direction, the connection conductor protrudes further outward from the endmost coil conductor than the connection conductor protrudes inward.

5. The multilayer coil component according to claim 1, wherein the connection conductor includes a portion continuous with the endmost coil conductor in the same layer as the endmost coil conductor.

6. The multilayer coil component according to claim 5, wherein the connection conductor does not overlap the coil when viewed from the first direction.

7. The multilayer coil component according to claim 6, wherein the connection conductor has the first thickness that is larger than a third thickness of a smallest thickness in the endmost coil conductor.

8. The multilayer coil component according to claim 7, wherein, in the first direction, the connection conductor protrudes further outward from the endmost coil conductor than the connection conductor protrudes inward.
